(19) United States
(12) Patent Application Publication
(10) Pub. No.: US 2023/0199400 A1
(43) Pub. Date: Jun. 22, 2023

(54) LOUDSPEAKER AND METHOD FOR MANUFACTURING THE SAME

(71) Applicant: PSS BELGIUM NV, Dendermonde (BE)

(72) Inventors: Johan SCHEPENS, Overmere (BE); Thomas VAN DEN KEYBUS, Borgerhout (BE); David CORYNEN, Geraardsbergen (BE)

(21) Appl. No.: 17/923,487

(22) PCT Filed: May 3, 2021
(86) PCT No.: PCT/EP2021/061511

§ 371 Date: Nov. 4, 2022

(30) Foreign Application Priority Data
May 7, 2020 (GB) 2006811.0

(51) Int. Cl. H04R 9/06; H04R 1/06; H04R 9/02; H04R 9/04; H04R 7/12; H04R 7/18; H04R 1/02; H04R 31/00

(52) U.S. Cl. CPC H04R 9/06; H04R 1/06; H04R 9/025; H04R 9/045; H04R 7/127; H04R 7/18; H04R 1/025; H04R 31/006; H04R 2499/13

(57) ABSTRACT

A loudspeaker includes: a non-perforated membrane having a front surface facing in a forward direction for producing sound to be radiated outwardly from the loudspeaker in the forward direction and a back surface facing in a backward direction opposite to the forward direction, a magnet unit configured to provide a magnetic field in a predetermined region of space, a voice coil rigidly connected to the membrane, and configured to produce in use a magnetic field which interacts with the magnetic field provided by the magnet unit in the predetermined region of space so as to move the membrane along a longitudinal axis of the loudspeaker, a lead wire configured to input a signal to the voice coil. The lead wire is guided to the voice coil via one or more deformed holders. The lead wire remains at a single surface of the membrane without perforating the latter.

### FIELD OF THE INVENTION

The present invention is generally related to the field of loudspeakers.

### BACKGROUND OF THE INVENTION

FIG. 1 illustrates a scheme of a loudspeaker as commonly known in the art. A loudspeaker has a membrane 10 (also often called diaphragm) having a front surface 11 facing in a forward direction 24 for producing sound to he radiated outwardly from the loudspeaker in the forward direction and a back surface 12 facing in a backward direction 28. Both the forward and backward directions 24, 28 extend along the longitudinal axis 33 of the loudspeaker. The membrane 10 is for example circular. The membrane 10 is suspended from a frame 5 of the loudspeaker by a rim 3 which is attached to an outer edge of the membrane 10 by glue, and which extends continuously around the outer edge of the membrane.

The loudspeaker also includes an electromagnetic drive unit comprising a magnet unit 4 and a voice coil former 8. The magnet unit provides a magnetic field in an air gap 35 located between two components of the magnet unit, typically a permanent magnet and a magnetic field guiding element. The voice coil former 8 is rigidly connected to the membrane 10. When in use, a current passes through a voice coil provided on the voice coil former, thereby producing a magnetic field. This magnetic field interacts with the magnetic field provided by the magnet unit 4 in the air gap 35 so as to move the membrane along a longitudinal axis 33 of the loudspeaker.

The membrane 10 has a hole at its centre to accommodate the voice coil former 8. A dustcap 2 attached to the front surface 11 (see FIG. 2) of the membrane (e.g. by glue), extends across and covers the hole in the middle of the membrane, so as to prevent dust from getting into the magnet unit 4 via the air gap and to provide an acoustic seal to prevent blowing noises to occur when the loudspeaker is mounted in a sealed enclosure.

As illustrated in FIG. 1, a lead wire 40 connecting the voice coil to the connector pins 1 is placed between the membrane 10 and the damper 20. The damper provides high radial stiffness and low axial stiffness so that the voice coil stays positioned in the centre of the airgap at rest or when traveling along the longitudinal axis. The membrane of the loudspeaker moves between a nominal position (i.e. a rest position, when the voice coil 25 does not have a current passing through it), a maximum extent in the forward direction and a maximum extent in the backward direction. The lead wire must be placed so that in the rest position as well as in moving condition there is no contact between the lead wire and the membrane or the damper. In other words, contact is to be avoided in all operation conditions, e.g. also when making a lot of stroke, to prevent noises from lead wires touching the diaphragm. A distance B as indicated in FIG. 1 is needed to meet such requirement. Lead wires between membrane and damper therefore lead to higher speakers.

In many applications there is only a limited amount of space to accommodate the loudspeaker. To reduce the total height of the loudspeaker, lead wires can be glued to the backside (i.e. the dry side) of the membrane as shown in FIG. 2. The lead wires need to be positioned properly on the membrane and glue needs to be applied and in most cases a curing time for the glue must be taken into account before executing the next process step in the assembly of the loudspeaker.

Alternatives exist wherein the lead wire is glued to the front of the membrane of the loudspeaker. When the connector pins are located at the backside of the membrane, the lead wires may in that case be guided through one or more hole(s) in the membrane to connect to the connector pins. The resulting opening after inserting the lead wire in the hole has to be closed to make the membrane tight again. The hole is commonly closed by means of glue.

Fast curing glues are however often not ecological and/or too expensive. Slow curing glues can be cheap but result in too high curing times, sometimes even combined with a considerable cost for heated buffers. The gluing of lead wire to the membrane results in most cases in substantial process variations.

In other conventional solutions the lead wires are guided over the damper. This can be done by knitting or by gluing one or more glue dots or by fully integrating the lead wire in the damper. This results in a high process cost and is often an unstable process. Lead wires can be integrated in the damper. This is a technically good solution, but leads to high cost.

Often a membrane is made of paper and woven fibres. Additives may be used in the paper to change the properties and to make the membrane watertight. Membranes made on woven fibres are often coated to make them tight. Such treatments lead to many leaking components due to process variation. Those coatings and/or additives are in many cases unfriendly for the environment.

In order to reduce the total speaker height the use of corrugated membranes has been proposed. An example can be found in WO2005/015950. The membrane has a pattern of folds between the inner and the outer edge of the membrane. The depth of the folds increases from the edges towards the centre.

Another way of reducing the total speaker height involves the use of an inverted driver. Such a loudspeaker with inverted cone is known from, for example, WO2004/017674. The movable body of the loudspeaker comprises, in the proximity of the base part of the diaphragm, a bridging dement which is secured to the movable part of the actuator and extends radially with respect to the translation axis, whereby the diaphragm and the bridging element are interconnected at least at a radial distance to the translatable part of the actuator. In this way the base part of the diaphragm is secured to the bridging element and thus indirectly connected to the translatable part of the actuator. As the base part is wider than the corresponding dimension of the translatable part of the actuator, the translatable part of the actuator can be shortened with respect to the length of the coil former of the inverted speaker. The loudspeaker so only has a limited axial dimension in spite of its three-dimensional diaphragm, so that it has a small depth.

One example of an application where a reduced speaker height is important, relates to speakers and speaker systems for creating sound at the exterior of a vehicle. Such solutions are applied e.g. in hybrid and electrical cars to warn pedestrians for a vehicle in the neighbourhood. Such speakers are mounted outside the passenger area. Clearly, in the vehicle there is only limited height available to install the speakers. Moreover, they have to withstand road and motor environment, which also implies resistance to humidity, mud, oils, fuels, crushed stones, . . . They further must withstand for example a high pressure waterjet during cleaning of the vehicle.

In JPH0286299A a speaker unit is disclosed wherein a hole is made in the diaphragm to insert a silver thread. A lead wire and the silver thread are soldered, whereby a fixed thermoplastic resin part is molten near the hole.

Hence, there is a need for a loudspeaker wherein one or more of the above-mentioned limitations and problems are avoided or overcome.

### SUMMARY OF THE INVENTION

It is an object of embodiments of the present invention to provide for a loudspeaker wherein there is no need to use expensive or non-ecological glues during the manufacturing process. The invention also relates to a method for producing such a loudspeaker.

The above objective is accomplished by the solution according to the present invention.

In a first aspect the invention relates to a loudspeaker comprising
a non-perforated membrane having a front surface facing in a forward direction for producing sound to be radiated outwardly from the loudspeaker in the forward direction and a back surface facing in a backward direction opposite to the forward direction,
a magnet unit configured to provide a magnetic field in a predetermined region of space,
a voice coil rigidly connected to said membrane, said voice coil being configured to produce in use a magnetic field which interacts with the magnetic field provided by the magnet unit in the predetermined region of space so as to move the membrane along a longitudinal axis of the loudspeaker,
a lead wire configured to input a signal to the voice coil,
   whereby the lead wire is guided to the voice coil via one or more deformed holders, said deformed holders forming an integral part of the membrane, whereby the lead wire remains at a single surface of the membrane without perforating the membrane.

The proposed solution indeed allows for fixing the lead wire to the non-perforated membrane without using any glue. This is made possible by providing on a surface of the membrane one or more holders which during the manufacturing process have been heated and deformed, so that the deformed holders guide the lead wire to the voice coil. The lead wire remains at a single surface of the non-perforated membrane.

In another aspect the invention relates to a process for manufacturing a loudspeaker, comprising the steps of:
providing a magnet unit in a frame, said magnet unit configured to provide a magnetic field in a predetermined region of space,
suspending a non-perforated membrane from the frame, said membrane having a front surface facing in a forward direction for producing sound to be radiated outwardly from the loudspeaker in the forward direction and a back surface facing in a backward direction opposite to the forward direction, said membrane provided with one or more holders to guide a lead wire configured to input a signal to the voice coil,
connecting rigidly a voice coil to the membrane, said voice coil being configured to produce in use a magnetic field which interacts with the magnetic field provided by the magnet unit in the predetermined region of space so as to move the membrane along a longitudinal axis of the loudspeaker,
fixing the lead wire to the membrane by heating and deforming the one or more holders, whereby the lead wire remains at a single surface of the membrane without perforating the membrane.
   The heating and deforming is preferably performed by heat staking or by vibration welding or ultrasonic welding.

In a preferred embodiment the holders are disposed at the back surface of the membrane.

In preferred embodiments the holders are made of plastic. Advantageously, the one or more holders are made of polypropylene.

In some embodiments the distance between two consecutive holders is at least 5 mm.

In advantageous embodiments one or more of the holders have parallel sides, whereby the lead wire can be guided between the two sides. Such holders then form guiding means that guide the lead wire over a certain distance to the voice coil.

In certain embodiments the two parallel sides of the holder to guide the lead wire do not have the same dimensions. For example, one side may be longer than the opposite side, and/or one side may be higher than the other one.

In some embodiments one or more pairs of holders are disposed parallel with each other with a narrow slot in between so that the lead wire can be guided through the slot so created.

In one embodiment the loudspeaker comprises a dustcap attached to the membrane. In a more specific embodiment the dustcap is integrated in the membrane.

In some embodiments the membrane has pattern of folds.

In some embodiments the lead wire is soldered on a solder pad on a voice coil former which establishes the rigid connection of the voice coil to the membrane.

In a preferred embodiment the one or more holders have a length of less than 5 mm.

In one aspect the invention also relates to the use of a loudspeaker as described above on the exterior side of a motor vehicle. When the holders are disposed on the back surface of the membrane there is no need to create one or more holes in the membrane, i.e. the membrane can remain unperforated, and problems due to e.g. humidity can be avoided, which is an major requirement for application in cars, trucks and the like, as well as for other types of outdoors use.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The above and other aspects of the invention will be apparent from and elucidated with reference to the embodiment(s) described hereinafter.

### BRIEF DESCRIPTION OF THE DRAWINGS

The invention will now be described further, by way of example, with reference to the accompanying drawings, wherein like reference numerals refer to like elements in the various figures.

FIG. 1 illustrates a loudspeaker as known in the prior art, with a lead wire between the membrane and the damper.

FIG. 2 illustrates a prior art solution with the lead wire glued to the backside of the membrane.

FIG. 3 illustrates an embodiment of a loudspeaker according to the present invention.

FIG. 4 illustrates a loudspeaker with a longer holder than in FIG. 3.

FIG. 5 illustrates an embodiment of a loudspeaker with a plurality of holders.

FIG. 6 illustrates a loudspeaker with corrugated membrane according to the invention.

FIG. 7 illustrates an embodiment of a flat loudspeaker according to the present invention.

FIG. 8 illustrates another view on the loudspeaker of FIG. 7.

FIG. 9 illustrates an inverted loudspeaker according to the invention.

FIG. 10 illustrates holders being disposed on the membrane before being deformation.

FIGS. 11a to 11d illustrates an embodiment of a method for manufacturing a loudspeaker according to the invention.

### DETAILED DESCRIPTION OF ILLUSTRATIVE EMBODIMENTS

The present invention will be described with respect to particular embodiments and with reference to certain drawings but the invention is not limited thereto but only by the claims.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

It should be noted that the use of particular terminology when describing certain features or aspects of the invention should not be taken to imply that the terminology is being re-defined herein to be restricted to include any specific characteristics of the features or aspects of the invention with which that terminology is associated.

In the description provided herein, numerous specific details are set forth. However, it is understood that embodiments of the invention may be practiced without these specific details. In other instances, well-known methods, structures and techniques have not been shown in detail in order not to obscure an understanding of this description.

The present invention discloses a method for manufacturing a loudspeaker wherein the use of glue to fix the lead wire to the membrane is avoided. Consequently there is also no curing time required related to the use of glue. In another aspect the invention also relates to a loudspeaker obtained by a manufacturing process as described.

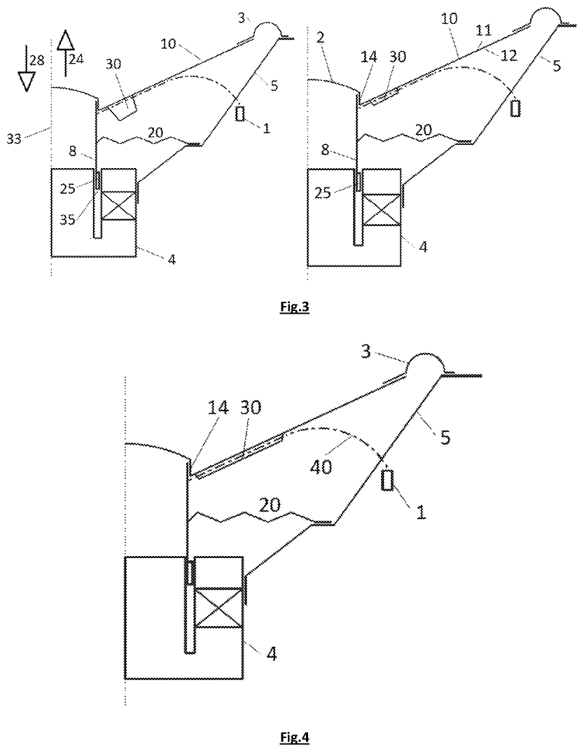

Similar to a prior art loudspeaker as already described in the background section, a loudspeaker according to the present invention comprises (see FIG. 3) an electromagnetic drive unit comprising a magnet unit 4 and a voice coil former 8. The electromagnetic drive unit is disposed in the frame 5. The magnet unit is configured to provide a magnetic field in an air gap 35 located between two components of the magnet unit, typically a permanent magnet and a magnetic field guiding element. The voice coil 25 is rigidly connected to the membrane 10. The rigid connection may be established by the voice coil former 8. The voice coil former may be a tube on which the voice coil is mounted. The voice coil is configured to produce a magnetic field when it is in use (by passing a current through it). The produced magnetic field interacts with the magnetic field provided by the magnet unit 4 in the air gap 35 so as to move a membrane 10 along a longitudinal axis 33 of the loudspeaker.

The non-perforated membrane 10 has a front surface 11 facing in a forward direction 24 and a back surface 12 facing in a backward direction 28. In embodiments the forward direction 24 may be opposite to the backward direction 28, and both the forward and backward directions 24, 28 extend along the longitudinal axis 33. The membrane 10 may be circularly shaped or may have another shape. The membrane 10 is suspended from a frame 5 of the loudspeaker by a rim 3 (e.g. a half-roll edge suspension) which is attached to an outer edge of the membrane 10, and which extends continuously around the outer edge of the membrane.

In embodiments of the present invention the lead wire, i.e. the electrical connection between the loudspeaker and the audio amplifiers, is fixed to the non-perforated membrane in a specific way. More particularly, the attachment of the lead wire to the membrane is obtained by providing one or more holders 30 that lead the lead wire along a surface of the membrane, in most preferred embodiments the back surface of the membrane. In advantageous embodiments the holders may be implemented as guiding means, i.e. holders which are provided with parallel sides between which the lead wire is guided over some distance. In other words, the sides of the holder define a slot wherein the lead wire is guided.

The holders are made in material that does not need any coatings or adhesives to make them tight. Molded plastics obtained starting from granulate or plastics starting from plastic sheets are suitable candidates for implementing the holders. For example, polypropylene is an appropriate plastic for the holders.

During the manufacturing process of the loudspeaker the one or more holders are then deformed by applying techniques like heat staking or vibration welding or ultrasonic sealing. In many embodiments the one or more holders are also softened in this manufacturing step. Heat staking, also known as thermoplastic staking, is the process of joining together two components in dissimilar materials, at least one of which is plastic, by raising the temperature of the plastic component(s) and allowing plastic deformation to be carried out. Vibration welding (also known as linear welding or friction welding) of thermoplastics refers to a process in which two components are brought in contact under pressure, and a reciprocating motion (vibration) is applied along the common interface in order to generate heat. The resulting heat melts the components, and they become welded when the vibration stops and the interface cools. In ultrasonic sealing high-frequency vibrations are locally applied to components being held together under pressure.

In case of the holder(s) being implemented with guiding sides, i.e. with guiding means as already mentioned previously, the sides still form a guiding path for the lead wire after the step of deforming and optional softening of the holder.

At the left hand side in FIG. 3 the holder for holding the lead wire is shown before the deformation has been performed. In the right hand side part of FIG. 3 a loudspeaker is illustrated with a deformed holder for the lead wire.

The size of a deformed and possibly softened holder that provides a fixing point to guide the lead wire along a part of the membrane may vary from one embodiment to another. In some embodiments the deformed holder may be as short as 0.5 mm, whereas in other embodiments the deformed holder may be 2 mm or 3 mm. FIG. 4 illustrates an embodiment with a longer holder than in FIG. 3.

In certain embodiments wherein the holder comprises two parallel sides that guide the lead wire, the two sides do not have exactly the same dimensions. For example, a long side and a short side may be provided, and/or one side may be higher than the other one.

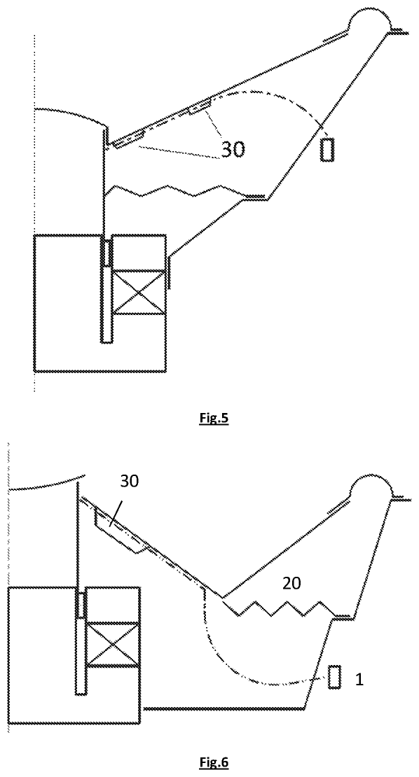

In some embodiments two or more deformed holders 30 can be provided on a line radially extending from the central part of the membrane towards the rim as illustrated in FIG. 5. In certain embodiments the distance between two consecutive holders may be 5 mm, 8 mm, 10 mm, 15 mm or more. One or more of the holders may be guiding means. In some embodiments various radial lines each comprising one or more holders can be provided spread over the surface of the membrane. The angle between the radial lines may be equal for every adjacent pair of radial lines or not.

The membrane 10 has a hole at its centre to accommodate the voice coil former. A dustcap 2 attached to the front surface 11 of the membrane, extends across and covers the hole in the middle of the membrane, so as to prevent dust from getting into the magnet unit 4 via the air gap 35. In preferred embodiments the dustcap 2 is not attached to the front surface 11 of the membrane by e.g. glue, but is integrated into the membrane. A cylindrical adaptor 14 for the coil former can be integrated in the membrane to guide and hold the voice coil assembly. The voice coil 25 is mounted on the coil former 8. This can also be seen in FIGS. 3 to 5. Integrating the dustcap into the membrane offers the advantage that these two components do not need to be connected anymore.

In order to further reduce the need for using glue, the glue connection between membrane and rim can be replaced by overmolding the membrane and the rim over each other.

In FIG. 6 is illustrated an embodiment of a loudspeaker according to this invention, wherein the membrane is corrugated. One holder is shown in the example illustrated in the figure. The membrane 10 has an outer circumferential edge suspended from the frame and an inner circumferential edge to which the translatable part of the drive unit 4 is secured. The membrane is provided with a pattern of radial folds extending over the surface of the membrane between the outer and the inner circumferential edge. The folds have a depth which increases from the outer circumferential edge towards a middle area formed by a ring-shaped zone between the two edges, and from the inner circumferential edge towards this middle area, where the maximum depth is located. The folds are provided with faces in the middle area which are used to obtain the ‘v’-shape. In the embodiment of FIG. 6 a damper 20 is provided between said faces and the frame. Alternatively a damper may be provided between the faces and the stationary part of the drive unit. The outer circumferential edge of the membrane is connected to the frame by a rim or other resilient means. A major advantage of the loudspeaker embodiment of FIG. 6 is its reduced height, while the sound performance remains unaffected. In other advantageous embodiments one or more holders may be provided in an implementation as described for example in WO2005/015950.

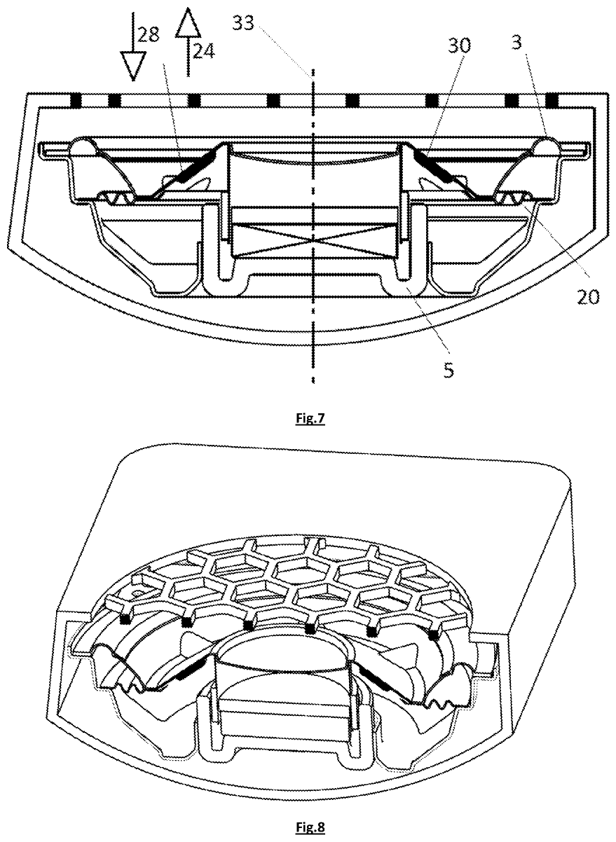

FIG. 7 illustrates a more detailed cross-sectional view of an embodiment of a flat loudspeaker as in FIG. 6, disposed in an enclosure that takes the form of a compact box. The damper 20 between the frame and the faces in the middle area gives additional stiffness. The damper extends completely around the drive unit. The damper may have the shape of a spider flexible in the direction of motion of the translatable part of the magnet unit but rigid in a direction perpendicular to that. As can be seen in the perspective view in FIG. 8, a grille is provided at the outer surface of the loudspeaker.

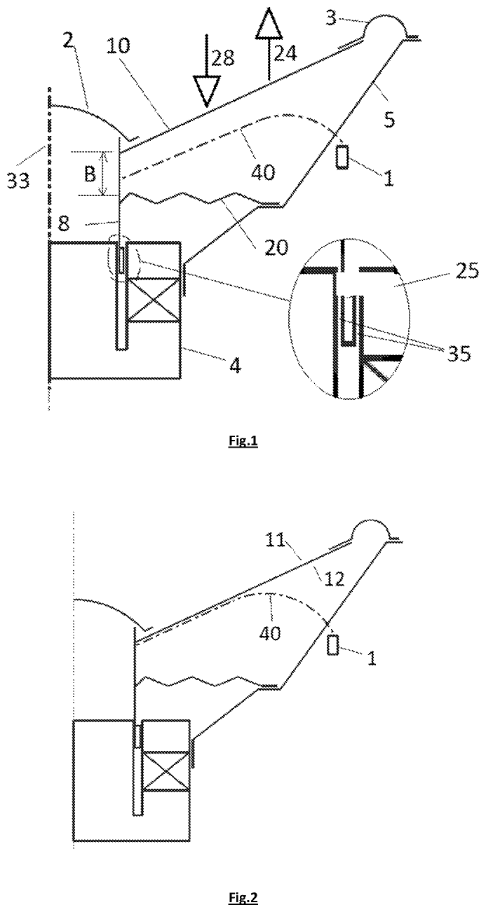

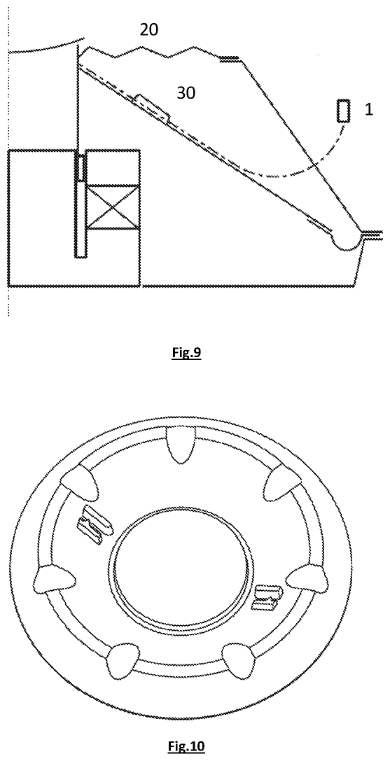

FIG. 9 illustrates another embodiment wherein the loudspeaker has an inverted cone, also called an inverted loudspeaker. Again a loudspeaker membrane with one holder is shown in the figure. Obviously this is merely an example and embodiments with more holders and differently placed holders are also possible, as the skilled person will readily recognize. Note that front surface and back surface of the membrane have now switched compared to the previous embodiments. Compared to FIGS. 1 to 5 the cone is now flipped with respect to the damper 20. An interesting feature of inverted loudspeakers is their flatness, i.e. they have a smaller axial dimension compared to loudspeakers wherein the drive unit is located behind the backplane of the speaker cone. An example is found in WO2004/017674, which was already briefly acknowledged in the background section. Embodiments with inverted cone, as e.g. described in WO2004/017674, can readily be extended to the approach according to this invention, wherein one or more holders that guide the lead wire to the voice coil, form an integral part of the membrane.

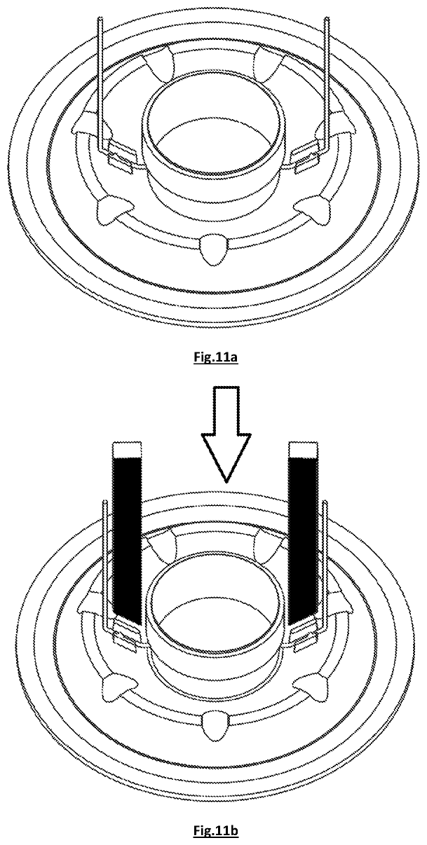

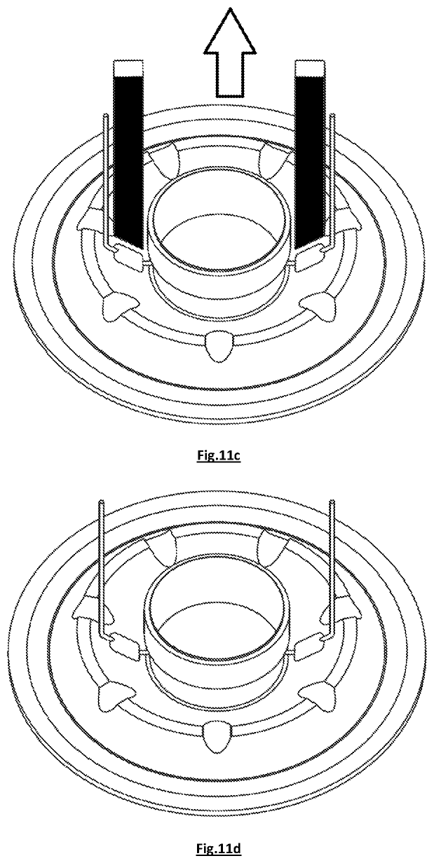

The invention also relates to a method for manufacturing a loudspeaker as set out above. FIGS. 10 and 11 further illustrate a possible embodiment of the method proposed in this invention. In FIG. 10 two sides of a holder which is integrally part of the membrane are disposed parallel with each other so that a lead wire can be guided between the two sides of the holder over some distance. In the embodiment shown in FIG. 8 the dimensions of the two sides are not equal: one is longer and higher than the other.

FIG. 11 then shows in detail the manufacturing steps wherein the lead wire is fixed to the non-perforated membrane. In FIG. 11a the lead wire is mounted in the cone and guided by the holder towards the voice coil former, both for the positive and the negative conductor in an implementation based on differential signalling as illustrated. The lead wire is preferably soldered on a soldering pad on the voice coil former. In FIG. 11b heat staking is applied to the holder by means of a jig. FIG. 11c then shows the jig being removed after the holder has been deformed. The lead wire still runs between the two sides of the deformed holder. FIG. 11d illustrates the resulting implementation.

Loudspeakers according to the present invention, and more in particular the embodiments of the flat loudspeakers are advantageously used in the automotive industry. Indeed, their compactness along with their being airtight and watertight, makes the loudspeakers very suitable to resist the road and motor environment as required for use in cars and other vehicles. In these embodiments the lead wire is fixed to the back surface of the membrane, so that no holes are needed in the membrane.

Another interesting application field for this type of loudspeakers is in outdoor applications, like e.g. a wearable box. Also in this case the lead wire is fixed to the back surface of the membrane, so that no holes in the membrane are needed.

A further important benefit of the proposed loudspeakers is that they can be produced by means of an environment friendly and highly efficient manufacturing process.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1.16. (canceled)

17. A loudspeaker comprising:
a membrane with a central hole and no further perforations and having a front surface facing in a forward direction for producing sound to be radiated outwardly from the loudspeaker in said forward direction and a back surface facing in a backward direction opposite to said forward direction,
a magnet unit configured to provide a magnetic field in a predetermined region of space,
a voice coil rigidly connected to said membrane, said voice coil being configured to produce in use a magnetic field which interacts with said magnetic field provided by said magnet unit in said predetermined region of space so as to move said membrane along a longitudinal axis of the loudspeaker,
a lead wire configured to input a signal to said voice coil,
wherein that said lead wire is guided to said voice coil via one or more deformed holders, said deformed holders forming an integral part of said membrane,
wherein said lead wire remains at a single surface of said membrane without perforating said membrane.

18. The loudspeaker as in claim 17, wherein said holders are disposed at said back surface of said membrane.

19. The loudspeaker as in claim 17, wherein said holders are made of plastic.

20. The loudspeaker as in claim 19, wherein said holders are made of polypropylene.

21. The loudspeaker as in claim 17, wherein the distance between two consecutive holders is at least 5 mm.

22. The loudspeaker as in claim 17, wherein one or more of said holders have parallel sides arranged to guide said lead wire.

23. The loudspeaker as in claim 17, wherein said parallel sides are different in at least one dimension.

24. The loudspeaker as in claim 17, comprising a dustcap attached to said membrane.

25. The loudspeaker as in claim 24, wherein said dustcap is integrated in said membrane.

26. The loudspeaker as in claim 17, wherein said membrane has a pattern of folds.

27. The loudspeaker as in claim 17, wherein said lead wire is soldered on a solder pad on a voice coil former establishing the rigid connection of said voice coil to said membrane.

28. A method for manufacturing a loudspeaker, the method comprising:
providing a magnet unit in a frame, said magnet unit configured to provide a magnetic field in a predetermined region of space,
suspending a membrane with a central hole and no further perforations from said frame, said membrane having a front surface facing in a forward direction for producing sound to be radiated outwardly from the loudspeaker in said forward direction and a back surface facing in a backward direction opposite to said forward direction, said membrane provided with one or more holders to guide a lead wire configured to input a signal to said voice coil,
connecting rigidly a voice coil to said membrane, said voice coil being configured to produce in use a magnetic field which interacts with said magnetic field provided by said magnet unit in said predetermined region of space so as to move said membrane along a longitudinal axis of the loudspeaker,
fixing said lead wire to said membrane by heating and deforming said one or more holders, wherein said lead wire remains at a single surface of said membrane without perforating said membrane.

29. The method for manufacturing a loudspeaker as in claim 28, wherein said heating and deforming of said one or more holders is performed by heat staking.

30. The method for manufacturing a loudspeaker as in claim 28, wherein said heating and deforming of said one or more holders is performed by vibration welding or ultrasonic welding.

31. The method for manufacturing a loudspeaker as in claim 28, wherein said one or more holders have a length of less than 5 mm.

32. Use of a loudspeaker as in claim 17, on the exterior side of a motor vehicle.
